(19) United States
(12) Patent Application Publication
(10) Pub. No.: US 2024/0208517 A1
(43) Pub. Date: Jun. 27, 2024

(54) VEHICLE CONTROL SYSTEM, VEHICLE CONTROL METHOD, AND STORAGE MEDIUM

(71) Applicants: HONDA MOTOR CO., LTD., Tokyo (JP); TOYOTA JIDOSHA KABUSHIKI KAISHA, Aichi (JP); Mazda Motor Corporation, Hiroshima (JP); MITSUBISHI JIDOSHA KOGYO KABUSHIKI KAISHA, Tokyo (JP); SUBARU CORPORATION, Tokyo (JP); NISSAN MOTOR CO., LTD., Yokohama-shi (JP); Isuzu Motors Limited, Yokohama-shi (JP)

(72) Inventors: Satoshi Kono, Tokyo (JP); Yuichi Koubata, Tokyo (JP); Kanako Saito, Tokyo (JP); Noriaki Fujie, Hiroshima (JP); Yasuharu Morimoto, Hiroshima (JP); Shintaro Matsuzaki, Tokyo (JP)

(21) Appl. No.: 18/393,995

(22) Filed: Dec. 22, 2023

(30) Foreign Application Priority Data
Dec. 26, 2022 (JP) 2022-208057

(51) Int. Cl. B60W 50/023; B60W 50/06

(52) U.S. Cl. CPC B60W 50/023; B60W 50/06

(57) ABSTRACT

A vehicle control system includes a first controller provided for each device mounted in a vehicle, a second controller configured to control one or more of the first controllers, and a third controller configured to control one or more of the second controllers. Each second controller is connected to the corresponding first controller via a communication line and performs a first process based on output information output from the device connected to the first controller. The third controller is connected to the corresponding second controller via a communication line and performs a second process based on a predetermined function of the vehicle. The predetermined function of the vehicle is performed by performing the first process and the second process.

### CROSS-REFERENCE TO RELATED APPLICATION

Priority is claimed on Japanese Patent Application No. 2022-208057, filed Dec. 26, 2022, the content of which is incorporated herein by reference.

### BACKGROUND

### Field of the Invention

The present invention relates to a vehicle control system, a vehicle control method, and a storage medium.

### Description of Related Art

In the related art, techniques for an electronic control system in which a plurality of electronic control units (ECUs) mounted in a vehicle perform cooperative processes while communicating with each other and operate individual actuators or sensors are known (for example, PCT International Publication No. WO2020/085330).

### SUMMARY

However, in the related art, how and in what situations a plurality of controllers mounted in a vehicle need to cooperate with each other has not been considered. In the related art, since application software (hereinafter referred to as software) for executing a function is installed in each controller and the corresponding ECU operates for each function, it is necessary to individually cope with the relevant ECUs when software is updated. Accordingly, it may not be possible to perform appropriate processes using a plurality of controllers.

The present invention was made in consideration of the aforementioned circumstances, and an objective thereof is to provide a vehicle control system, a vehicle control method, and a storage medium that can perform more appropriate processes using a plurality of controllers.

A vehicle control system a vehicle control method, and a storage medium according to the present invention employ the following configurations.

(1) A vehicle control system according to an aspect of the present invention is a vehicle control system including: a first controller provided for each device mounted in a vehicle: a second controller configured to control one or more of the first controllers; and a third controller configured to control one or more of the second controllers, wherein each second controller is connected to the corresponding first controller via a communication line and performs a first process based on output information output from the device connected to the first controller, the third controller is connected to the corresponding second controller via a communication line and performs a second process based on a predetermined function of the vehicle, and the predetermined function of the vehicle is performed by performing the first process and the second process.

(2) In the aspect of (1), each first controller may include a first information acquirer configured to acquire first information output from the corresponding device, each second controller may include a signal information extractor configured to extract signal information from the first information detected by the first information acquirer as the first process, and the third controller may include a first function controller configured to perform the predetermined function of the vehicle on the basis of the signal information extracted by the signal information extractor as the second process.

(3) In the aspect of (2), the signal information extractor may perform a filtering process of dividing the first information into the signal information and noise information and output the signal information to the third controller.

(4) In the aspect of (2), each second controller may further include a second function controller configured to perform the predetermined function of the vehicle on the basis of the signal information extracted by the signal information extractor, and the third controller may further include a switcher configured to perform a switching process of switching between whether the predetermined function of the vehicle is to be performed by the first function controller and whether the predetermined function of the vehicle is to be performed by the second function controller.

(5) In the aspect of (4), the third controller may detect a traffic volume in a communication line connecting the third controller and the one or more second controllers and perform the switching process according to the detected traffic volume.

(6) In the aspect of (5), the third controller may cause the switcher to perform the switching process and cause the second function controller to perform the predetermined function of the vehicle as the second process when the traffic volume of the communication line is greater than a predetermined volume.

(7) In the aspect of (1), the third controller may determine operation details for performing the predetermined function of the vehicle as the second process, one of the third controller and the second controller may generate an operation command based on the operation details on the basis of the determined operation details, the second controller may generate operation execution information based on the device connected to the corresponding first controller as the first process, and the first controller may cause the device to perform the predetermined function of the vehicle on the basis of the operation execution information.

(8) In the aspect of (7), when a predetermined event occurs in the vehicle, the corresponding second controller may generate operation execution information for causing the device connected to the corresponding first controller to perform the predetermined function of the vehicle, and the first controller may perform the predetermined function of the vehicle on the basis of the operation execution information.

(9) A vehicle control method according to another aspect of the present invention is a vehicle control method that is performed by a computer of a vehicle control system including a first controller provided for each device mounted in a vehicle, a second controller configured to control one or more of the first controllers, and a third controller configured to control one or more of the second controllers, the vehicle control method including: causing each second controller to perform a first process based on output information output from the device connected to the corresponding first controller; causing the third controller to perform a second process based on a predetermined function of the vehicle; and causing the device to perform the predetermined function of the vehicle by performing the first process and the second process.

(10) A non-transitory computer-readable storage medium according to another aspect of the present invention is a non-transitory computer-readable storage medium storing a program, the program causing a computer of a vehicle control system including a first controller provided for each device mounted in a vehicle, a second controller configured to control one or more of the first controllers, and a third controller configured to control one or more of the second controllers to perform: causing each second controller to perform a first process based on output information output from the device connected to the corresponding first controller; causing the third controller to perform a second process based on a predetermined function of the vehicle; and causing the device to perform the predetermined function of the vehicle by performing the first process and the second process.

According to the aspects of (1) to (10), it is possible to perform more appropriate processes using a plurality of controllers.

### BRIEF DESCRIPTION OF THE DRAWINGS

FIG. 1 is a diagram illustrating an example of a configuration of a vehicle control system according to an embodiment.

FIG. 2 is an example of a functional configuration of a device ECU.

FIG. 3 is an example of a functional configuration of a zone ECU.

FIG. 4 is an example of a functional configuration of a central ECU.

FIG. 5 is a diagram illustrating function dividing (function partitioning) in an input process.

FIG. 6 is a diagram illustrating function dividing (function partitioning) in an output process.

FIG. 7 is a diagram illustrating saturation of a traffic volume based on a band of a communication line connecting a zone ECU and the central ECU.

FIG. 8 is a diagram illustrating an example in which some processes which are performed by the central ECU are performed by a zone ECU side.

FIG. 9 is a diagram illustrating an operation of a switcher.

FIG. 10 is a diagram illustrating a switching example according to a communication band.

FIG. 11 is a diagram illustrating an example of signal list information.

FIG. 12 is a diagram illustrating communication signal information.

FIG. 13 is a diagram illustrating reduction of a traffic volume based on communication signal information.

FIG. 14 is a diagram illustrating an example of communication signal information before and after being compressed.

FIG. 15 is a diagram illustrating a flow of a fail-safe process using the central ECU.

FIG. 16 is a diagram illustrating a flow of a fail-safe process not using the central ECU.

FIG. 17 is a flowchart illustrating an example of an input process in the vehicle control system.

FIG. 18 is a flowchart illustrating an example of an output process in the vehicle control system.

### DESCRIPTION OF EMBODIMENTS

Hereinafter, a vehicle control system, a vehicle control method, and a storage medium according to an embodiment of the present invention will be described with reference to the accompanying drawings. In the following example, it is assumed that the vehicle control system is mounted in a mobile object such as a vehicle with four wheels, but the vehicle control system may be mounted in a control device other than a mobile object. The mobile object is not limited to a vehicle with four wheels, may include a vehicle with three wheels or a vehicle with two wheels, or a micro-mobility, and may include all mobile objects in which a person (a driver) is. In the following description, it is assumed that the mobile object is a vehicle with four wheels and is referred to as a “vehicle M.”

### [Entire Configuration]

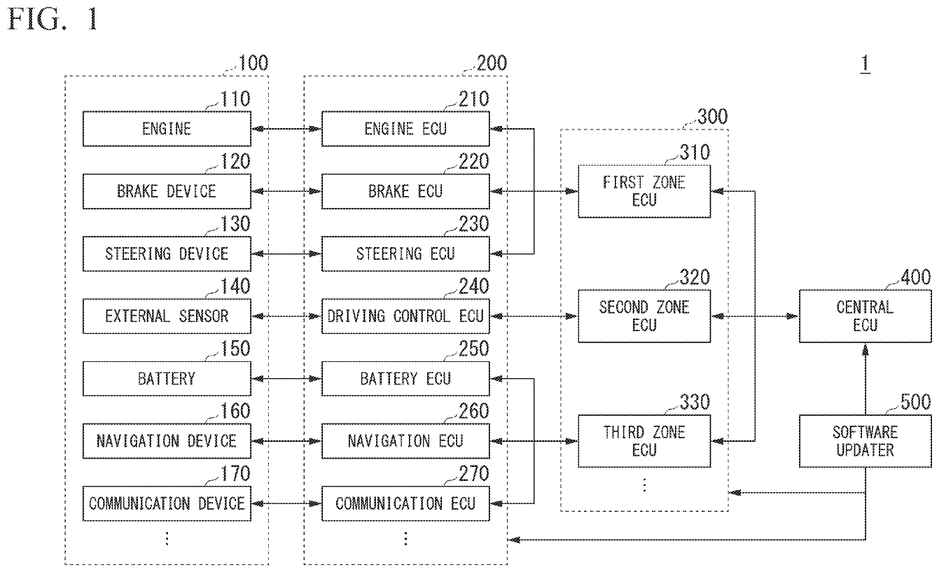

FIG. 1 is a diagram illustrating an example of a configuration of a vehicle control system 1 according to an embodiment. For example, the vehicle control system 1 includes various devices 100 mounted in a vehicle M, a device electronic control unit (ECU) 200, a zone ECU 300, a central ECU 400, and a software updater 500. Each of the device ECU 200, the zone ECU 300, the central ECU 400, and the software updater 500 is realized, for example, by causing a hardware processor such as a central processing unit (CPU) to execute a program (software). Some or all of these constituents may be realized by hardware (a circuit part: including circuitry) such as a large scale integration (LSI) circuit, an application-specific integrated circuit (ASIC), a field-programmable gate array (FPGA), or a graphics processing unit (GPU) or may be cooperatively realized by software and hardware. The program may be stored in a storage device (a storage device including a non-transitory storage medium) such as a hard disk drive (HDD) or a flash memory of the vehicle control system 1 in advance, or may be stored in a removable storage medium such as a DVD or a CD-ROM and installed in the HDD or the flash memory of the vehicle control system 1 by loading the storage medium (non-transitory storage medium) to a drive device. The vehicle control system 1 is an example of a “control system.” The device ECU 200 is an example of a “first controller.” The zone ECU 300 is an example of a “second controller.” The central ECU 400 is an example of a “third controller.” Each ECU performs communication with another ECU or the software updater 500 via a predetermined network. The predetermined network is, for example, a network based on a controller area network (CAN), a CAN with flexible data rate (CAN-FD), a local interconnect network (LIN), or Ethernet (registered trademark). The network may have a tree shape, a star shape, or a combined shape thereof.

The various devices 100 are devices for performing predetermined functions of the vehicle M. The various devices 100 includes, for example, an engine 110, a brake device 120, a steering device 130, an external sensor 140, a battery 150, a navigation device 160, and a communication device 170, but are not limited thereto. Each of the various devices is connected to a sensor or an actuator corresponding to a function thereof.

The device ECU 200 is an electronic control unit that is provided for each device of the various devices 100. In the example illustrated in FIG. 1, an engine ECU 210 that controls the engine 110, a brake ECU 220 that controls the brake device 120, a steering ECU 230 that controls the steering device 130, a driving control ECU 240 that controls the engine 110, the brake device 120, and the steering device 130 on the basis of results of detection from the external sensor 140, a battery ECU 250 that controls charging/discharging of the battery 150, a navigation ECU 260 that controls the navigation device 160, and a communication ECU 270 that controls the communication device 170 are examples of the device ECU 200. The device ECU 200 is not limited to the aforementioned types.

The engine ECU 210 controls the engine 110 that outputs a travel driving force for allowing the vehicle M to travel to driving wheels. For example, the engine ECU 210 acquires information on a rotation speed or the like of the engine 110 on the basis of information input from the driving control ECU 240 or information input from an accelerator pedal included in an operator (not illustrated) and controls an operation state of the engine 110 by adjusting a throttle valve opening, an amount of supplied fuel, or the like such that the engine 110 generates a target engine torque on the basis of the acquired information.

The brake ECU 220 controls braking of the vehicle M using the brake device 120. The brake device 120 includes, for example, a brake caliper, a cylinder that transmits a hydraulic pressure to the brake caliper, and an electric motor that generates a hydraulic pressure in the cylinder. The brake ECU 220 controls the electric motor on the basis of the information input from the driving control ECU 240 or the information input from a brake pedal included in the operator 90 such that a brake torque based on a braking operation is output to vehicle wheels. The brake device 120 may include a mechanism for transmitting a hydraulic pressure generated by an operation of the brake pedal to the cylinder via a master cylinder as a backup. The brake device 120 is not limited to the above-mentioned configuration, and may be an electronically controlled hydraulic brake device that controls an actuator on the basis of information input from the driving control ECU 240 such that the hydraulic pressure of the master cylinder is transmitted to the cylinder.

The steering ECU 230 controls steering of the vehicle M using the steering device 130. The steering device 130 includes, for example, an electric motor. The electric motor changes a direction of turning wheels, for example, by applying a force to a rack-and-pinion mechanism. The steering ECU 230 drives the electric motor of the steering device 130 on the basis of the information input from the driving control ECU 240 or the information input from a steering wheel included in the operator such that the direction of the turning wheels is changed.

The driving control ECU 240 performs driving control of the vehicle M, for example, on the basis of recognition results of the surroundings of the vehicle M from the external sensor 140. Driving control is supporting driving of an occupant of the vehicle M, for example, by controlling one or both of steering and speed of the vehicle M. Examples of the driving control include adaptive cruise control (ACC), lane keeping assistance system (LKAS), traffic jam pilot (TJP), auto lane changing (ALC), collision mitigation brake system (CMBS), and vehicle stability assist (VSA).

The external sensor 140 acquires information, for example, from a camera, a radar device, and a finder and recognizes an object near the vehicle M. The camera images the surroundings of the vehicle M and generates a captured image. The camera is, for example, a digital camera using a solid-state imaging device such as a charge-coupled device (CCD) or a complementary metal oxide semiconductor (CMOS). The camera is attached to an arbitrary position on the vehicle M in which the vehicle control system 1 is mounted. The surroundings of the vehicle M may include a space in front of the vehicle M and a lateral space or a rear space of the vehicle M. For example, when a front view of the vehicle M is imaged, the camera is attached to an upper part of a front windshield, a rear surface of a rearview mirror, or the like. The camera may be a stereoscopic camera. The radar device detects at least a position (a distance and a direction) of an object by radiating radio waves such as millimeter waves in a predetermined radiation direction around the vehicle M and detecting radio waves (reflected waves) reflected by the object. Examples of the object include another vehicle, an obstacle, and a structure which are present near the vehicle M. One or more radar devices are attached to arbitrary positions on the vehicle M. The radar device may detect a position and a speed of an object using a frequency modulated continuous wave (FM-CW) method. The finder is a Light Detection and Ranging or Laser Imaging Detection and Ranging (LIDAR) that detects a distance to an object by measuring scattered light of radiated light radiated in a predetermined direction around the vehicle M. One or more finders are attached to an arbitrary position on the vehicle M.

The external sensor 140 may perform a sensor fusion process on results of detection from some or all of the camera, the radar device, and the finder and recognize a position, a type, a speed, and the like of an object near the vehicle M. The external sensor 140 may recognize a road shape, a marking, a lane marking, and the like near the vehicle M through the sensor fusion process. The external sensor 140 outputs the results of recognition to the driving control ECU 240.

The driving control ECU 240 acquires control information for the engine ECU 210, the brake ECU 220, and the steering ECU 230 such that predetermined driving control is performed on the basis of the recognition results from the external sensor 140. The predetermined driving control is driving control, based on a traveling state of the vehicle M or a driving state of an occupant, and specific examples thereof include driving control for avoiding a contact between the vehicle M and an object, driving control for curbing departure from a traveling lane, and driving control for traveling to follow a preceding vehicle.

The battery ECU 250 performs energy control of an amount of energy, charging/discharging, or the like of the battery 150 mounted in the vehicle M. The battery ECU 250 supplies electric power of the battery 150 to, for example, various devices 100, an operator, a display, the software updater 500, and other electrical instruments of the vehicle M. The battery ECU 250 may supply electric power from the battery 150 to a predetermined instrument on the basis of operation details on an ignition device. Energy used for performing a process of updating software or the like is mainly supplied from the battery 150 to an ECU to be updated.

The battery ECU 250 may perform control for charging the battery 150, for example, using a regenerative current generated by operation of the brake device 120. For example, the battery ECU 250 may perform control for storing energy supplied from an external charging facility via a charging connector or the like in the battery 150. The battery ECU 250 measures a terminal voltage of the battery 150 and acquires an energy residual (a state of charge (SOC)) on the basis of the measured magnitude of the terminal voltage. For example, the battery ECU 250 may acquire the energy residual by integrating a current quantity stored at the time of charging using a current detection resistor and calculating a current quantity output at the time of discharging or may store a database of discharging characteristics, temperature characteristics, and the like of the battery in a storage or the like in advance and acquire the energy residual on the basis of the measured voltage value or current value and the database.

The navigation ECU 260 controls the navigation device 160 mounted in the vehicle M. The navigation device 160 includes, for example, a global navigation satellite system (GNSS) receiver, a navigation human-machine interface (HMI), and a route determiner. The GNSS receiver identifies a position of the vehicle M on the basis of signals received from GNSS satellites. The navigation HMI includes a display, a speaker, a touch panel, and keys. The navigation HMI may cause an occupant to set a destination or the like using an image, speech, or the like or guides the occupant for a traveling route to the destination. For example, the route determiner determines a route (hereinafter referred to as a route on a map) from the position of the vehicle M identified by the GNSS receiver (or an input arbitrary position) to a destination input by an occupant using the navigation HMI with reference to map information or the like. The navigation ECU performs route guidance or the like by displaying a map image on the navigation HMI or display (not illustrated) or outputting speech from a speaker (not illustrated) on the basis of the route on a map.

The communication ECU 270 controls the communication device 170 mounted in the vehicle M. The communication device 170 is a communication interface for allowing the vehicle M to communicate with an external device. For example, the communication device 170 may be a wireless local area network (LAN) interface based on Wi-Fi (registered trademark), Bluetooth (registered trademark), or the like or may be a wide area network (WAN) for accessing a cellular network, a dedicated line, or the like. The communication ECU 270 transmits data to an external device or receives information from an external device via the communication device 170 and outputs the received information to a predetermined ECU.

The zone ECU 300 is electrically connected to the device ECU 200, acquires output information output from a device connected to the device ECU 200, and performs a process (a first process) on the basis of the acquired output information. For example, the zone ECU 300 controls one or more device ECUs which are grouped according to predetermined conditions out of the device ECUs 200. The predetermined conditions may be, for example, a condition based on a function of the device correlated with the device ECU 200 or may be a condition based on a traffic volume between the ECUs (the zone ECU 300 and the device ECU 200) in a predetermined time, a process load, a process frequency, and the number of processing times.

In the example illustrated in FIG. 1, each of a first zone ECU 310, a second zone ECU 320, and a third zone ECU 330 is an example of the zone ECU 300. The first zone ECU 310 is connected to the engine ECU 210, the brake ECU 220, and the steering ECU 230 and performs a predetermined process on the device ECUs 200. The second zone ECU 320 is connected to the driving control ECU 240 and performs a predetermined process on the driving control ECU 240. The third zone ECU 330 is connected to the battery ECU 250, the navigation ECU 260, and the communication ECU 270 and performs a predetermined process of the device ECUs 200. The number of zone ECUs 300 or groups of zone ECUs are not limited to the example illustrated in FIG. 1.

The central ECU 400 is electrically connected to the zone ECU 300 and performs a process (a second process) based on a predetermined function of the vehicle M. In this embodiment, the predetermined function of the vehicle M is performed by performing the first process and the second process. The central ECU 400 is connected to the zone ECUs 300 (the first to third zone ECUs 310 to 330 in FIG. 1) and performs a predetermined process on the zone ECUs 300. In the example illustrated in FIG. 1, since a zone ECU 300 present between the central ECU 400 and the device ECU 200 includes a controller, it is possible to perform a process more suitable for each ECU and to optimize costs by limiting the roles thereof. For example, in the vehicle control system 1, the various devices 100 are grouped by functions and the zone ECUs 300 are provided in the groups. For example, an actuator operates in response to an instruction from the central ECU 400, and a sensor transmits the detected information as a signal to the central ECU 400.

The software updater 500 updates software installed in each of a plurality of ECUs that control predetermined functions of the vehicle M (functions of the devices) mounted in the vehicle M through communication with an external device via the communication device 170. Updating of software includes, for example, version-up of software stored in advance in the storage provided in the EC, installation of new software in the storage, and deletion of unnecessary software from the storage. The software updater 500 selects a target ECU corresponding to updating details out of the device ECUs 200, the zone ECUs 300, and the central ECU 400 and updates software installed in the selected ECU. For example, when process details depending on a sensor on the device side are updated, software installed in the zone ECUs 300 is updated. When process details depending on functions or operations of the vehicle M are updated, software installed in the central ECU 400 is updated. Update of the device ECU 200 or the zone ECU 300 may be performed via the central ECU 400. In this case, software of the ECUs is received from the software updater 500, and the central ECU 400 updates the ECU to be updated.

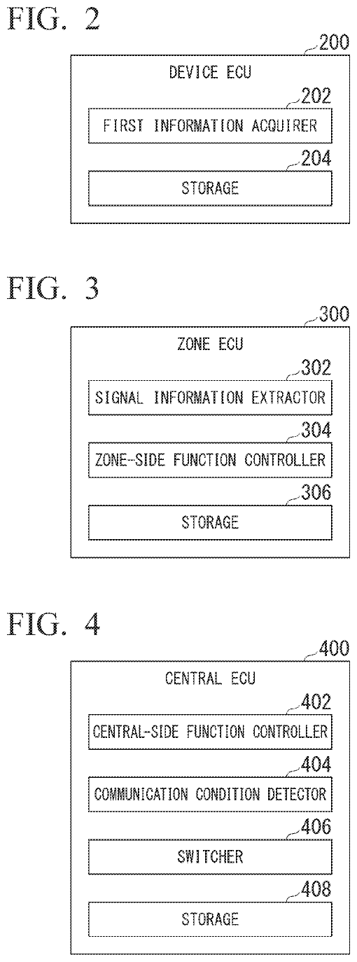

Functional configurations of the device ECU 200, the zone ECU 300, and the central ECU 400 will be described below. In the following description, the device ECUs and the zone ECUs are generically referred to as a “device ECU 200” and a “zone ECU 300.” FIG. 2 is a diagram illustrating an example of the functional configuration of the device ECU 200. The device ECU 200 includes, for example, a first information acquirer 202 and a storage 204. The first information acquirer 202 acquires first information output from a device electrically connected thereto. The first information is, for example, an electrical signal. The first information includes, for example, detection results from the sensors in the devices, amounts of driving of actuators, whether there is an abnormality, and various types of other information. The storage 204 is, for example, a nonvolatile memory such as an electrically erasable programmable read only memory (EEPROM) or a flash memory. Software (programs) installed in the device ECU 200, configuration information on the device ECU 200, process results in the device ECU 200, and the like are stored in the storage 204. The configuration information includes, for example, hardware identification information and software identification information. The hardware identification information includes, for example, component numbers (hardware numbers) and unique IDs (serial numbers) of devices. The software identification information includes identification information (a software number) and version information of each module of software. The hardware number or the software number may include, for example, function types, configuration types, component types, variation information, and other supplementary information (for example, maker numbers).

FIG. 3 is a diagram illustrating an example of the functional configuration of the zone ECU 300. The zone ECU 300 includes, for example, a signal information extractor 302, a zone-side function controller 304, and a storage 306. The zone-side function controller 304 is an example of a “second function controller.” The signal information extractor 302 extracts signal information from the first information acquired by the first information acquirer 202 as the first process. For example, the signal information extractor 302 performs a filtering process of dividing the first information into signal information and noise information and outputs signal information acquired through the filtering process (noise-removed) to the central ECU 400.

When an execution instruction from the central ECU 400 is received, the zone-side function controller 304 performs control for realizing a predetermined function of the vehicle M on the basis of the signal information extracted by the signal information extractor 302.

The storage 306 is, for example, a nonvolatile memory such as an EEPROM or a flash memory. Software (programs) installed in the zone ECU 300, configuration information on the zone ECU 300, process results in the zone ECU 300, and the like are stored in the storage 306. The zone ECU 300 may have a function of performing AD conversion (analog/digital conversion) or DA conversion (digital/analog conversion) in addition to the aforementioned configuration.

FIG. 4 is a diagram illustrating an example of the functional configuration of the central ECU 400. The central ECU 400 includes, for example, a central-side function controller 402, a communication condition detector 404, a switcher 406, and a storage 408. The central-side function controller 402 is an example of a “first function controller.” The central-side function controller 402 performs control for realizing a predetermined function of the vehicle M on the basis of the signal information extracted by the signal information extractor 302 as the second process. The central-side function controller 402 may perform various output processes on the basis of input information in accordance with a control application (software). For example, the central-side function controller 402 may perform a process (moving average filtering or the like) for ascertaining discrete signals as a continuous signal or a process for extracting meaning information (for example, increasing a wiper speed when an automatic wiper function is used and it starts to rain suddenly) required for a function side (application) from data and determining operation details for the corresponding device on the basis of the meaning information.

The communication condition detector 404 detects a communication condition in a communication line (network) connecting the central ECU 400 and the zone ECU 300. The communication condition is, for example, a traffic volume. The communication condition detector 404 may detect a change in traffic volume in a predetermined time or may predict a traffic volume in the near future (after several seconds) from the change. The communication condition detector 404 detects the communication condition, for example, using functions such as packet capture, simple network management protocol (SNMP), and NetFlow.

The switcher 406 performs a switching process of switching between whether control for realizing a predetermined function of the vehicle M is to be performed by the central-side function controller 402 and whether control for realizing the predetermined function of the vehicle M is to be performed by the zone-side function controller 304. For example, the switcher 406 performs the switching process according to a traffic volume in the communication line connecting the central ECU 400 and the zone ECU 300 detected by the communication condition detector 404. For example, the switcher 406 causes the zone-side function controller 304 to perform the predetermined function of the vehicle M when the traffic volume in the communication line is greater than a predetermined volume and causes the central-side function controller 402 to perform the predetermined function of the vehicle M when the traffic volume in the communication line is equal to or less than the predetermined volume. The switcher 406 may cause the zone-side function controller 304 to perform the predetermined function of the vehicle M when a communication band in the communication line is narrow (equal to or less than a predetermined band) and cause the central-side function controller 402 to perform the predetermined function of the vehicle M when the communication band in the communication line is wide (greater than the predetermined band). By performing this switching, it is possible to curb occurrence of a delay of data at the time of transmission between the ECUs due to an increase in traffic volume for the communication band and to perform processes suitable for the ECUs. The switcher 406 outputs an execution instruction to the function controller that performs control for realizing the predetermined function of the vehicle M.

The storage 408 is, for example, a nonvolatile memory such as an EEPROM or a flash memory. Software (programs) installed in the central ECU 400, configuration information on the central ECU 400, process results in the central ECU 400, and the like are stored in the storage 408. Signal list information or communication signal information for ascertaining or adjusting details of signals input and output between the ECUs may be stored in the storage 408. The functions of the constituents of the ECUs illustrated in FIGS. 2 to 4 may be realized by software corresponding to the functions.

For example, the central ECU 400 generates an operation instruction signal for performing a predetermined function of the vehicle M as the second process. The zone ECU 300 generates a second operation signal based on the operation instruction signal as the first process. The second operation signal may include information on the device ECU 200. That is, the zone ECU 300 may generate a second operation instruction signal on the basis of information of devices connected to the device ECU 200. The device ECU 200 performs the predetermined function of the vehicle M to correspond to the devices connected thereto on the basis of the second operation instruction signal. The device information is, for example, a function type (for example, a motor) of a device connected to the device ECU 200, an operation which can be output from an actuator (for example, an operation range of a rotation speed or the number of rotations) when the actuator is included in the device, or an electrical signal (for example, a signal acquired from a temperature sensor or a physical switch for opening/closing a window) detected by a sensor when it is a sensing-based device. The predetermined function of the vehicle M is, for example, a function or an operation of the vehicle M which is performed using a device, such as an accelerating/decelerating operation, a steering operation, a battery operation, a navigation operation, or a communication control operation. The predetermined function may include functions associated with direction indicator operation, air-conditioner control, and music or radio reproduction operation

### <Function Dividing Between ECUs>

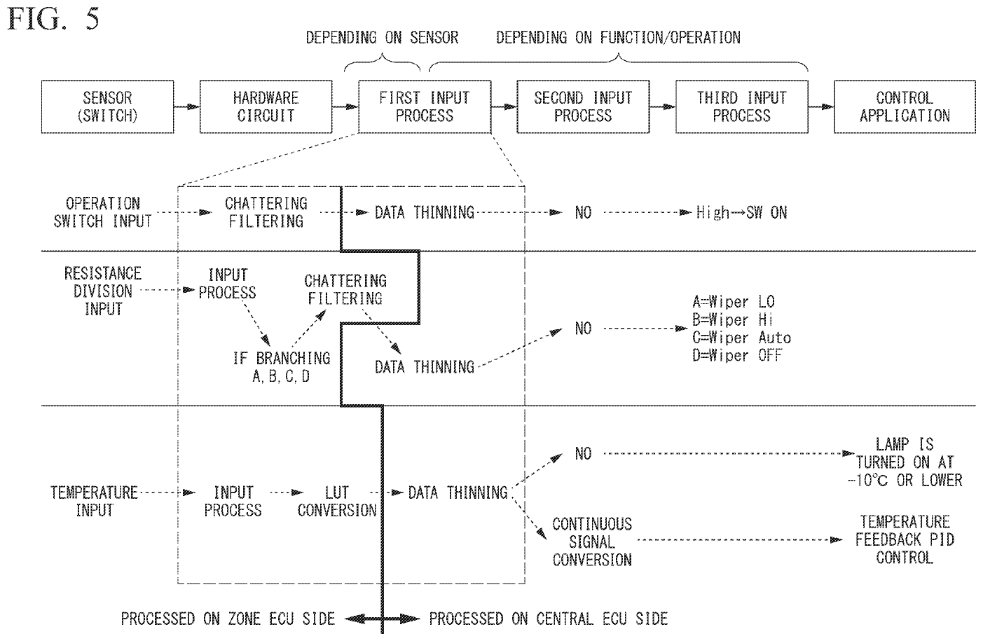

Partitioning of functions between the zone ECU 300 and the central ECU 400 (by what ECU a certain process is to be performed) will be described below with reference to a specific example of data. In the following description, description will be divided into an input process and an output process. FIG. 5 is a diagram illustrating function dividing (function partitioning) in an input process. A sensor (or a switch) and a hardware circuit illustrated in FIG. 5 are examples of various devices (terminal devices) 100. The hardware circuit may include the device ECU 200. In the example illustrated in FIG. 5, a first input process, a second input process, and a third input process are performed via the hardware circuit as needed in response to information input to the sensor, and then comprehensive control based on a control application is performed.

The first input process is, for example, a process of dividing an electrical signal into a signal (meaningful) and noise (meaningless) and extracting only the signal. The second input process is, for example, a process of grasping discrete signals (meaningful) as a continuous signal. The third input process is, for example, a process of extracting a meaning required for a function side from data. Details of the third input process differ depending on requirements of the function side (for example, for what or how the information is to be used). The first input process mainly includes a part depending on a performance or the like of a sensor and a part depending on a function or an operation, and the second input process and the third input process mainly include a part depending on a function/operation of the vehicle M.

In the example illustrated in FIG. 5, an input to an operation switch, an input (an analog input) of resistance division information of a wiper switch, and a temperature input (an analog input) are information which is acquired by the first information acquirer 202 of the device ECU 200. Division of the functions between the zone ECU 300 and the central ECU 400 in association with the first input process is performed according to the type of information or the like.

For example, when an input to an operation switch is acquired, the zone ECU 300 (the signal information extractor 302) performs chattering filtering on the input signal as the first input process, and the central ECU 400 (the central-side function controller 402) performs data thinning as the first input process. In the third input process, the central-side function controller 402 outputs a switch-on (SW ON) signal to the control application when the switch input is high.

For example, when an input of resistance division of a wiper switch is acquired, the zone ECU 300 performs a process of IF branching (branching to one of A, B, C, and D) on the switch input process as the first input process and additionally performs chattering filtering. The central ECU 400 performs data thinning as the first input process. The central ECU 400 sets wiper control operations correlated with A, B, C, and D which are acquired through the IF branching as the third input process. In the example illustrated in FIG. 5, “Wiper LO” is set when the switch input is A, “Wiper Hi” is set when the switch input is B, “Wiper Auto” is set when the switch input is C, and “Wiper OFF” is set when the switch input is D.

For example, when a temperature input is acquired, the zone ECU 300 performs an input process and conversion (for example, conversion based on sensor characteristics) using a lookup table (LUT) as the first input process. The central ECU 400 performs data thinning as the first input process. The central ECU 400 may perform a process such as continuous signal conversion using data after the data has been thinned according to the type of the control application or the like. The central ECU 400 turns on a lamp (ON) at 10° C. or lower or performs temperature feedback proportional integral differential (PID) control as control of the control application.

As illustrated in FIG. 5, a process depending on a sensor (the first input process depending on a sensor) such as a filtering process for deleting unnecessary signals or a process using a lookup table for enhancing process efficiency is performed by the zone ECU 300, and a subsequent process (a process for causing the vehicle M to perform a predetermined function or operation or the first input process depending on a function/operation) is performed by the central ECU 400.

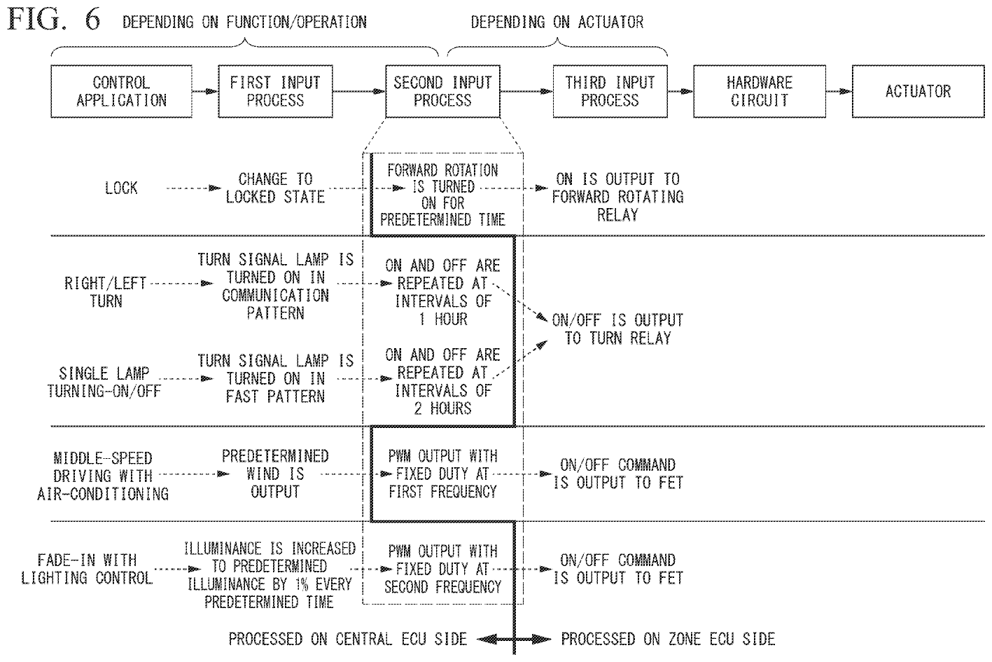

FIG. 6 is a diagram illustrating function dividing (function partitioning) in an output process. An actuator and a hardware circuit illustrated in FIG. 6 are examples of various devices (terminal devices) 100. The actuator is, for example, for driving a motor, a solenoid, or a valve. The hardware circuit may include the device ECU 200. In the example illustrated in FIG. 6, a first output process, a second output process, and a third output process are performed in response to input information acquired by the control application, and then the actuator is driven via the hardware circuit. As the first output process, for example, instruction details (an amount of driving) for a control target device (the actuator) are determined. For example, the instruction details indicate an amount of operation or the like of the vehicle M. As the second output process, for example, an operation command for realizing an amount of operation is output. The operation command is, for example, instruction information for converting an individual operation to behavior. As the third output process, for example, an operation based on the process result (the operation command) of the second output process is performed. The operation is, for example, on/off control of a switching element such as a relay element or a field effect transistor (FET) element.

In the example illustrated in FIG. 6, function dividing when a door unit of the vehicle M is locked, when a traveling direction (right turn or left turn) is indicated with a turn signal lamp, when single lamp turning-on/off is notified, when middle-speed driving with air conditioning is performed, and when fade-in control (lighting-up control) with lighting control is performed is illustrated.

For example, when a lock instruction is input to the control application, the central ECU 400 (the central-side function controller 402) determines an operation of changing the door unit to a locked state as the first output process. The zone ECU 300 (the zone-side function controller 304) generates an operation command for turning on forward rotation of a mechanism locking the door unit for a predetermined time as the second output process and controls the actuator for performing an output operation (ON output) of switching a relay element rotating forward on as the third process.

When right turn or left turn is performed, the central ECU 400 determines an operation of causing a turn signal lamp to blink in a normal pattern as the first output process and generates an operation command for repeating turning-on and turning-off of the turning signal lamp at intervals of a first period as the second output process. The zone ECU 300 controls the actuator such that the turn relay performs an operation of repeating ON/OFF output at intervals of the first period as the third output process. When single lamp turning-on/off is notified, the central ECU 400 determines an operation of causing the turn signal lamp to blink in a normal pattern as the first output process and generates an operation command for repeating turning-on and turning-off of the turn signal lamp at intervals of a second period shorter than the first period as the second output process. The zone ECU 300 controls the actuator such that the turn relay repeats ON/OFF output at intervals of the second period as the third output process.

When middle-speed driving with air-conditioning controller is performed, the central ECU 400 determines an operation of outputting a predetermined wind volume corresponding to middle-speed driving as the first output process. The zone ECU 300 generates an operation command for performing pulse width modulation (PWM) output with a first frequency and a fixed duty as the second output process and issues an ON/OFF instruction to the FET element as the third output process. When fade-in control with lighting control is performed, the central ECU 400 determines an operation of increasing illuminance by 1% to a predetermined illuminance in a predetermined time as the first output process and generates an operation command for performing PWM control with a second frequency and a variable duty as the second output process. The zone ECU 300 issues an ON/OFF instruction to the FET element as the third output process.

In this way, in the output process, the central ECU 400 determines operation details for performing a predetermined function of the vehicle M as the second process (the first output process), one of the central ECU 400 and the zone ECU 300 generates an operation command based on the operation details on the basis of the determined operation details (the second output process), and the zone ECU 300 generates operation execution information based on a device connected to the device ECU 200 as the first process (the third output process). Accordingly, the device ECU 200 performs the predetermined function of the vehicle M corresponding to the device (such as an actuator) on the basis of the operation execution information. Particularly, in the second output process, as illustrated in FIG. 6, the operation command when locking or middle-speed driving is performed is generated by the zone ECU 300, and the operation command associated with right/left turn, notification of single lamp turning-on/off, and fade-in control is generated by the central ECU 400. That is, as illustrated in FIG. 6, in the output process, a process depending on a function or operation requirements for the vehicle M (the second output process depending on a function/operation) is performed by the central ECU 400, and a process for achieving control thereof (the second output process depending on an actuator) is performed by the zone ECU 300. By what ECU of the central ECU 400 and the zone ECU 300 a certain process is to be performed may be set for each function or for each device and may be stored in the storage 408 or the like.

Here, when a configuration in which many functions are performed by the central ECU 400 is employed, an amount of information which is transmitted from the zone ECU 300 to the central ECU 400 particularly in the input process is increased, the traffic volume is saturated, and there is a likelihood that data will not be able to be transmitted or a transmission delay will be caused.

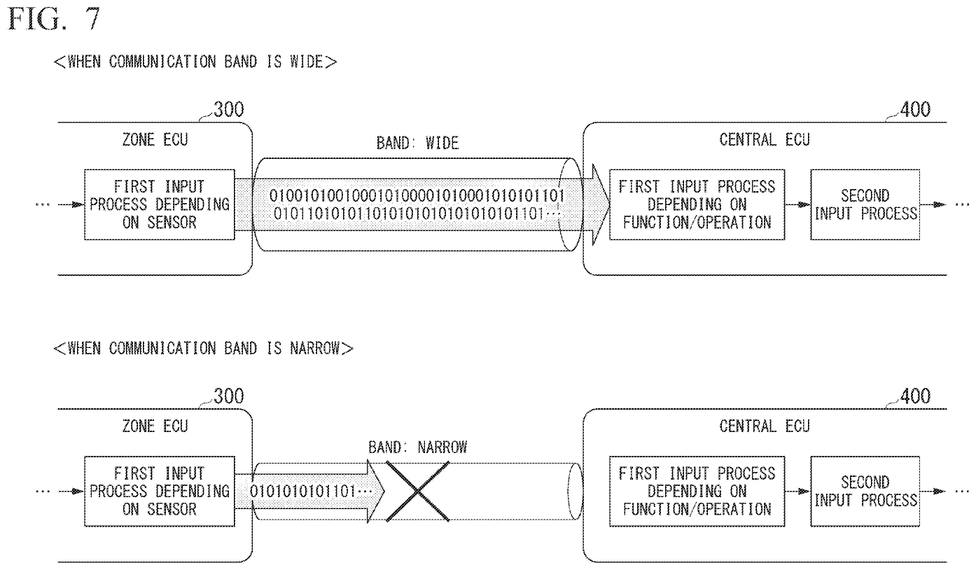

FIG. 7 is a diagram illustrating saturation of a traffic volume based on a band in a communication line connecting the zone ECU 300 and the central ECU 400. For example, when the communication band of the communication line (network) connecting the zone ECU 300 and the central ECU 400 is wide (when the communication band is wider than a predetermined band), a large amount of information can be transmitted even if an execution result of the first input process depending on a sensor is output to the central ECU 400 via the communication line, and thus the central ECU 400 can perform processing without delay. However, when the communication band is narrow (when the communication band is narrower than the predetermined band), an amount of information after the first input process depending on a sensor may not be able to be transmitted without a delay, a delay may be caused in the central ECU 400, and processes may not be able to be performed normally.

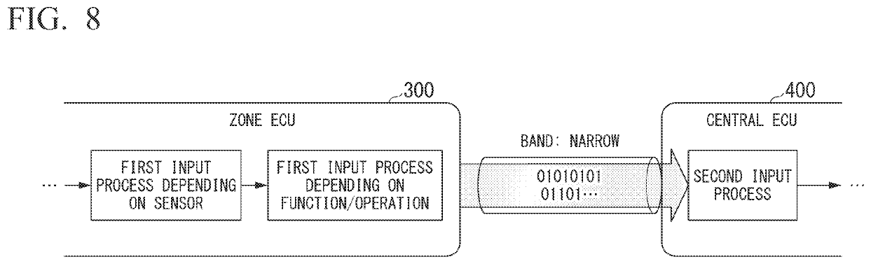

Accordingly, in the embodiment, when the communication band is narrow (when a sufficient band is predicted not to be secured), some of the processes performed by the central ECU 400 (the central-side function controller 402) are performed by the zone ECU 300 (the zone-side function controller 304) instead. FIG. 8 is a diagram illustrating an example in which some of the processes performed by the central ECU 400 are performed by the zone ECU 300. In the example illustrated in FIG. 8, the first input process depending on a function/operation is performed by the zone ECU 300. When the band of the communication line connected to the zone ECU 300 is narrow, the central ECU 400 performs control for causing the zone ECU 300 to perform the first input process depending on a function/operation. In the embodiment, instead of allowing the central ECU 400 to automatically determine a band and to switch to an ECU that performs the process as described above, a designer or an operator, or the like may change an ECU that performs the process on the basis of conditions of the communication band. By causing the zone ECU 300 to perform the first input process depending on a function/operation (for example, a thinning process). An amount of data smaller than an amount of data output after the first input process depending on a sensor is transmitted to the central ECU 400, and thus it is possible to appropriately transmit information without a delay even when the communication band is narrow.

The communication band fluctuates according to operation conditions, communication conditions, and the like of the devices. Accordingly, when the central ECU 400 determines that the communication band is not secured on the basis of the detection result from the communication condition detector 404, the first input process depending on a function/operation is performed by the zone ECU 300. When the communication band can be secured, the first input process is performed by the central ECU 400. Accordingly, in the embodiment, a “function (the switcher 406) that can switch a process with only a configuration” is provided as basic software (BSW) common to the zone ECU 300 and the central ECU 400 to perform control.

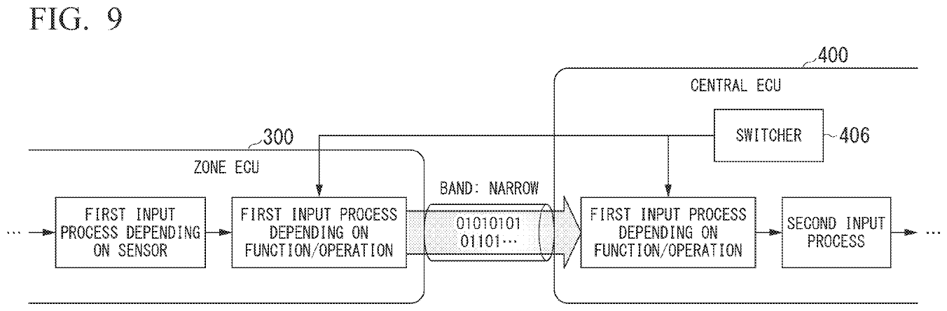

FIG. 9 is a diagram illustrating the operation of the switcher 406. In the example illustrated in FIG. 9, a configuration in which the first input process depending on a function/operation can be performed by both the zone ECU 300 and the central ECU 400 is employed. The first input process may be realized, for example, by common basic software. The first input process is performed by the zone-side function controller 304 of the zone ECU 300 and is performed by the central-side function controller 402 of the central ECU 400. The switcher 406 switches an execution destination of the first input process depending on a function/operation to one of the zone ECU 300 and the central ECU 400 according to the communication band of the communication line connected to the zone ECU 300 or current communication condition.

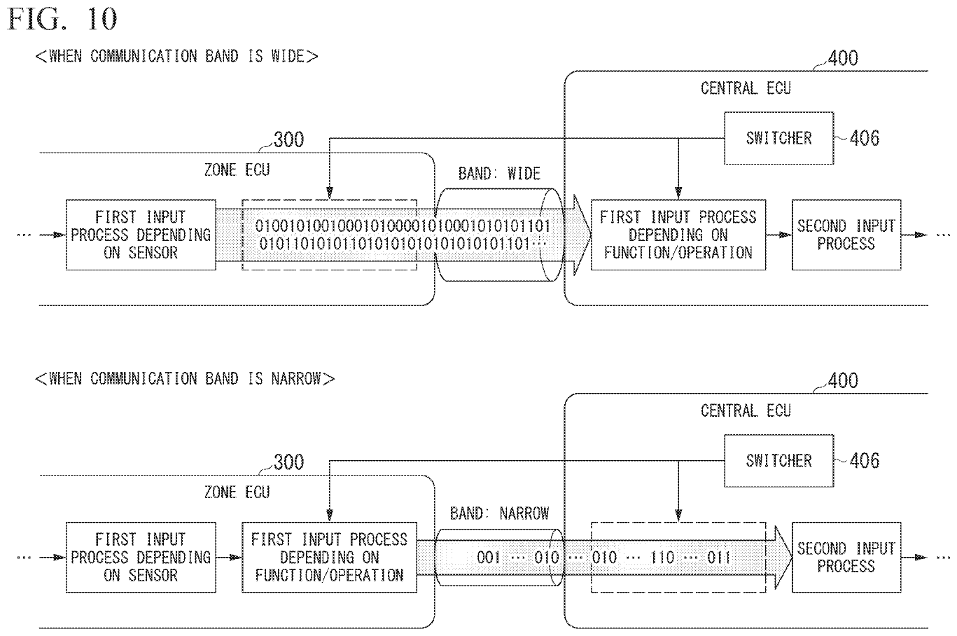

FIG. 10 is a diagram illustrating a switching example according to a communication band. As illustrated in FIG. 10, when the communication band is wide, the switcher 406 performs a switching process such that the central ECU 400 instead of the zone ECU 300 performs the first input process depending on a function/operation. On the other hand, when the communication band is narrow, the switcher 406 performs the switching process such that the zone ECU 300 instead of the central ECU 400 performs the first input process depending on a function/operation. Accordingly, it is possible to flexibly switch the process even when a traffic volume increases or decreases. When the communication line is replaced, update (such as rewriting) of software assembled into a corresponding ECU can be avoided and thus it is possible to reduce the cost.

Instead of (or in addition to) switching the process details between the zone ECU 300 and the central ECU 400, details of signals to be transmitted or a transmission period may differ according to the communication band or the like. In this case, the central ECU 400 adjusts a traffic volume on the basis of a communication signal table stored in the storage 408.

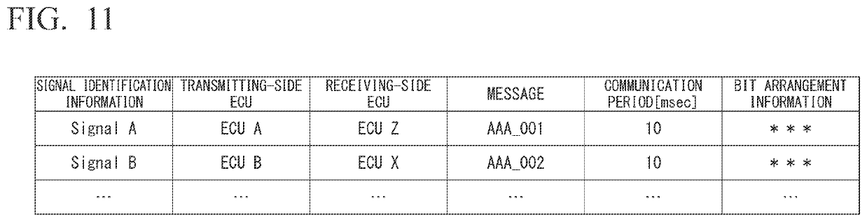

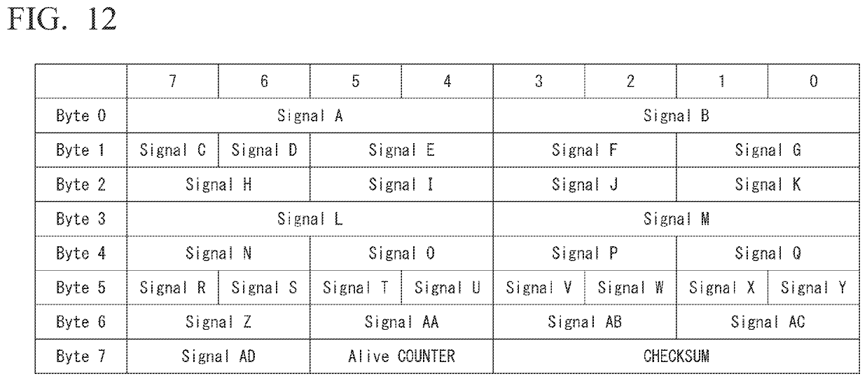

FIG. 11 is a diagram illustrating an example of signal list information. The signal list information illustrated in FIG. 11 is, for example, information in which signal identification information, a transmitting-side EC, a receiving-side ECU, message information, a communication period, and bit arrangement information are correlated. The message includes specific data details included in a signal. The bit arrangement information includes information indicating what bit of the signal or information indicating in what place of the communication signal information the signal is arranged.

FIG. 12 is a diagram illustrating communication signal information. In the communication signal information illustrated in FIG. 12, 30 types of signals (Signal A to Signal AD) and information for detecting a device (ECU) for transmission or reception or a data state (for example, detecting an abnormality or an error) such as alive counter or checksum are arranged in bits (0 to 7 bits) of 8 bytes (Byte 0 to Byte 7). In transmitting and receiving data, basic information may be transmitted to a transmission destination (a receiving side) in advance before a signal is transmitted, and information of a transmission source may be included in the basic information or information of a transmission source may be included in the header of the signal to be transmitted.

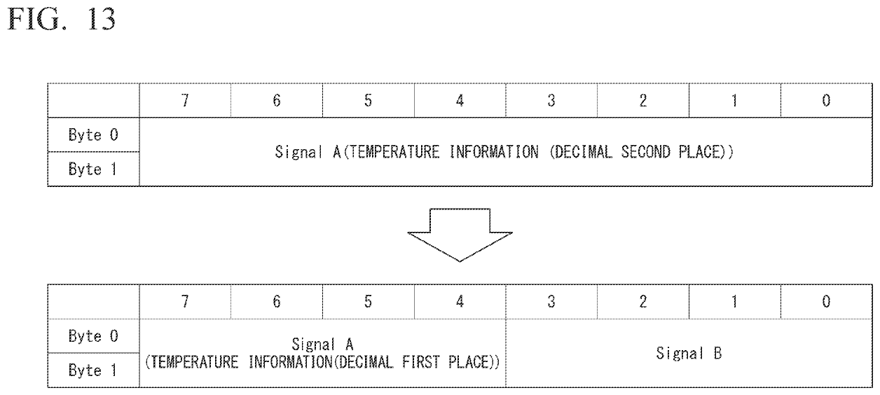

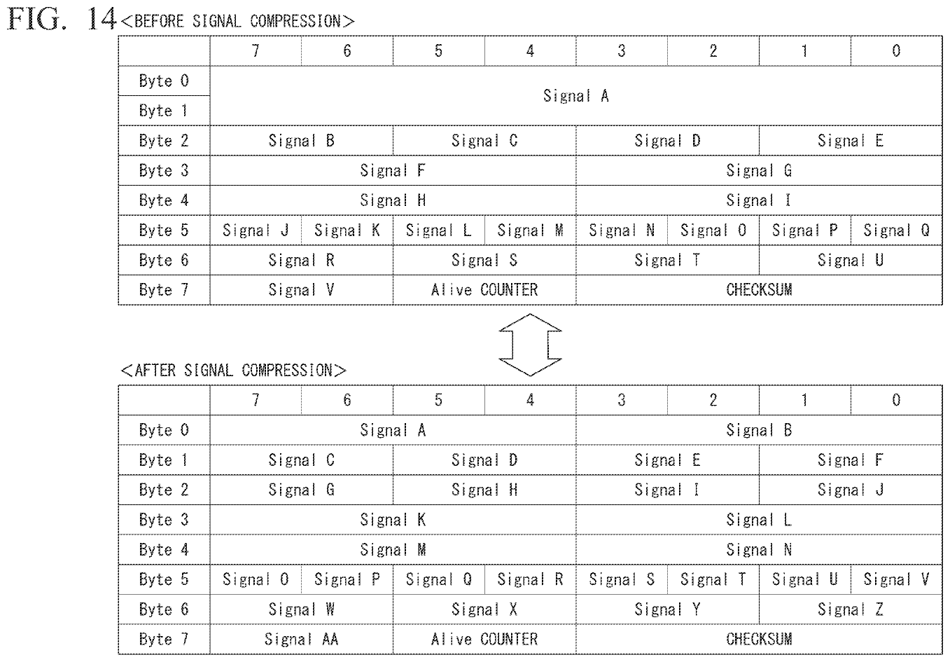

FIG. 13 is a diagram illustrating decreasing a traffic volume on the basis of communication signal information. In the example illustrated in FIG. 13, details stored in the bits of 2 bytes (Byte 0 and Byte 1) are illustrated. For example, when a traffic volume is decreased by changing details of data, the number of bits used for a predetermined signal is decreased. For example, when Signal A is information indicating temperature information and is a signal for transmitting the temperature information with a traffic volume to a decimal second place, the zone-side function controller 304 of the zone ECU 300 can decrease the number of bits used for transmission by changing (compressing) the temperature information to a traffic volume to a decimal first place. In the example illustrated in FIG. 13, Signal A having used 16 bits can be decreased to 8 bits. Since the number of types of signals which can be transmitted once is increased by inserting information of another signal (for example, Signal B) into an empty region, the zone-side function controller 304 can compress an amount of data as a whole and can transmit the signal without a delay even when a communication band with the central ECU 400 is narrow. The zone-side function controller 304 may transmit information indicating whether a transmitted signal is compressed to the central ECU 400.

FIG. 14 is a diagram illustrating an example of communication signal information before and after being compressed. In the example illustrated in FIG. 14, since the amount of data of Signal A is decreased through a compression process, more types of signals can be stored correspondingly. In the example illustrated in FIG. 14, only Signal A is compressed, but predetermined other data may be compressed. By storing a conversion table (communication signal information before and after being compressed) illustrated in FIG. 14 in the storage 408, the central ECU 400 can more accurately ascertain details of a communication signal depending on whether a signal acquired from the zone ECU 300 has been compressed. The zone-side function controller 304 of the zone ECU 300 may decrease a traffic volume in a predetermined time by increasing (delaying) a transmission period of a signal instead of (or in addition to) compression of a communication signal.

In this way, by switching a process between the zone ECU 300 and the central ECU 400 or changing details or a period of a signal to be transmitted, it is possible to satisfy restrictions due to a communication line or the like and to realize unification or lean development of the zone ECU 300. While the input process has been mainly described above, switching of a process between the zone ECU 300 and the central ECU 400 may also be performed in the output process.

### Modified Examples

In the vehicle control system 1 according to the embodiment, when a predetermined event occurs in the vehicle M, the zone ECU 300 may generate instruction information for performing a predetermined function of the vehicle M without using the central ECU 400 and output the generated instruction information to the device ECU 200. The predetermined event is, for example, an event requiring quick responsiveness, and an example thereof is an abnormality such as device failures (for example, a motor short circuit or an overcurrent failure). The predetermined function of the vehicle M in this case is a fail-safe process. For example, when a motor is short-circuited, a predetermined process such as stop of supply of electric power or turning-off of a relay is performed as the fail-safe process. Since the fail-safe process also depends on a “function,” control using the central ECU 400 is normally performed.

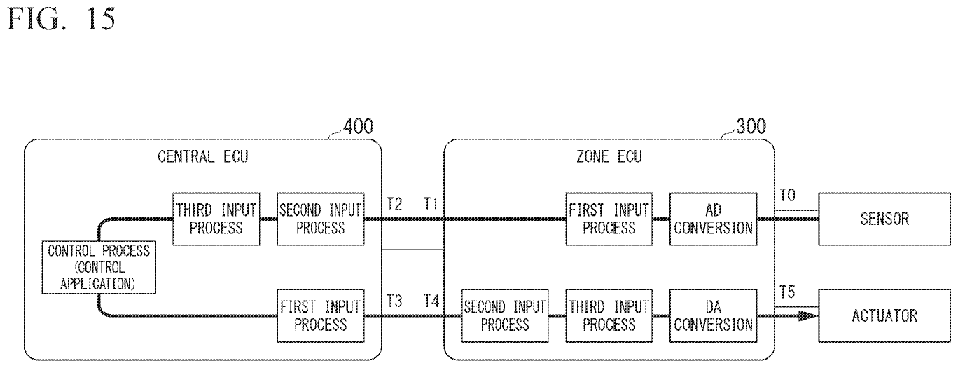

FIG. 15 is a diagram illustrating an example of a process flow of a fail-safe process using the central ECU 400. In the example illustrated in FIG. 15, the zone ECU 300 receives a signal detected by a sensor at time T0 and performs AD conversion or a first input process, and transmits a resultant signal to the central ECU 400 at time T2. The central ECU 400 receives the signal from the zone ECU 300 at time T2, performs a second input process, a third input process, a control process (abnormality detection) using a control application, a first output process (operation determination), and the like, and outputs a resultant signal to the zone ECU 300 at time T3. The zone ECU 300 receives information from the central ECU 400 at time T4, performs a second output process (operation command), a third output process (operation execution), DA conversion, and the like, and transmits an operation signal to a target device (for example, an actuator) at time T5 to perform an operation or the like based on the fail-safe process.

However, in performing fail-safe or the like, there is a likelihood that responsiveness will decrease when processes are performed using the central ECU 400. Accordingly, when an abnormality is detected, the zone ECU 300 performs all the processes such that the central ECU 400 does not participate therein as illustrated in FIG. 15.

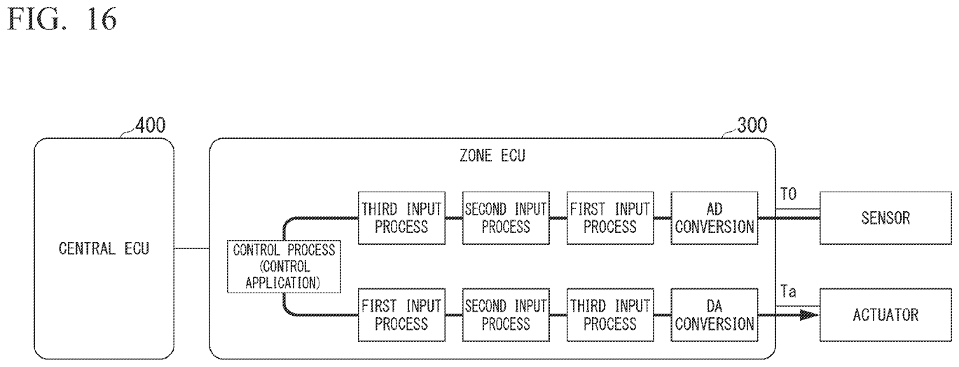

FIG. 16 is a diagram illustrating an example of a process flow of a fail-safe process without using the central ECU 400. When a fail-safe process is performed without using the central ECU 400, the zone ECU 300 generates operation execution information for causing a device connected to the device ECU 200 to perform a predetermined function of a vehicle M. Accordingly, the device ECU 200 can perform the predetermined function of the vehicle M on the basis of the operation execution information generated by the zone ECU 300. In the example illustrated in FIG. 16, the zone ECU 300 acquires information detected by a sensor and performs AD conversion, first to third input processes, a third process, a control process, first to third output processes, DA conversion, and the like. Accordingly, time Ta (an elapsed time from time T0) in which information is output from the zone ECU 300 is shorter than time T5 in FIG. 15. The zone ECU 300 switches to the process flow illustrated in FIG. 16 when an abnormality such as a failure is detected or when the fail-safe process is performed. Accordingly, it is possible to satisfy quicker responsiveness in the fail-safe process. In this case, a function which can be performed by the central ECU 400 is also provided in the zone ECU 300, and a switching process of switching between the zone ECU 300 and the central ECU 400 is performed in the control process of the zone ECU 300. In the embodiment, in addition to the fail-safe process, a switching process of switching between a process using the central ECU 400 (the process illustrated in FIG. 15) and a process without using the central ECU 400 (the process illustrated in FIG. 16) may be performed automatically according to responsiveness at the time of performing a function. In this case, the zone ECU 300 or the central ECU 400 measures a time until an operation of a device is started after a control command has been output from the central ECU 400 and causes the process without using the central ECU 400 to be performed when the measured time is greater than a reference time. Accordingly, it is possible to realize a process with quicker responsiveness.

### [Process Flow]

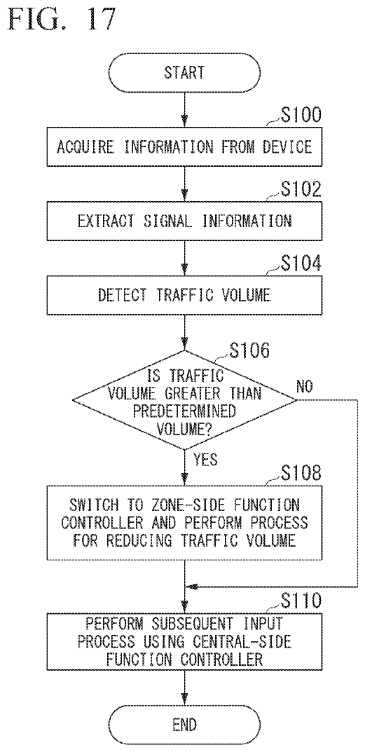

A process flow which is performed by the vehicle control system 1 according to the embodiment will be described below. In the following description, an input/output process which is mainly performed by an ECU out of processes which are performed by the vehicle control system 1 will be described. In the following description, description will be divided into an input process and an output process. FIG. 17 is a flowchart illustrating an example of an input process in the vehicle control system 1. In the example illustrated in FIG. 17, the device ECU 200 acquires information from a device connected thereto (Step S100). Then, the zone ECU 300 extracts signal information from the acquired information (Step S102). Then, the central ECU 400 detects a traffic volume of a communication line connecting the zone ECU 300 and the central ECU 400 (Step S104) and determines whether the traffic volume is greater than a predetermined volume (Step S106). When it is determined that the traffic volume is greater than the predetermined volume, the central ECU 400 switches the zone-side function controller 304 to perform a process for decreasing the traffic volume (Step S108). After the process of Step S108 or when it is determined in Step S106 that the traffic volume is not greater than the predetermined volume, the central ECU 400 causes the central-side function controller 402 to perform subsequent input processes (Step S110). In this way, the process flow in the flowchart ends.

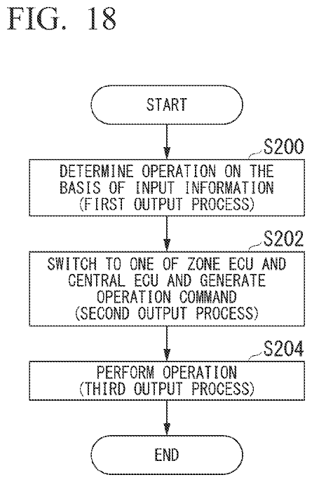

FIG. 18 is a flowchart illustrating an example of an output process in the vehicle control system 1. In the example illustrated in FIG. 18, the central ECU 400 determines operation details for causing the vehicle M to perform a predetermined function as the first output process on the basis of the input information (Step S200). Then, the central ECU 400 switches to one of the zone ECU 300 and the central ECU 400 on the basis of details of the input information and a type of a device to be operated or the determined operation details and generates an operation command as the second output process (Step S202). Then, the zone ECU 300 outputs an operation execution instruction to the device ECU 200 as the third output process to operate the target device (Step S204). In this way, the process flow in the flowchart ends.

According to the aforementioned embodiment, the vehicle control system 1 includes a device ECU (an example of a first controller) 200 provided for each device mounted in a vehicle M, a zone ECU (an example of a second controller) 300 configured to control one or more of the device ECUs 200, and a central ECU (an example of a third controller) 400 configured to control one or more of the zone ECUs 300, the zone ECU 300 is connected to the corresponding device ECU 200 via a communication line and performs a first process based on output information output from the device connected to the device ECU 200, the central ECU 400 is connected to the corresponding zone ECU 300 via a communication line and performs a second process based on a predetermined function of the vehicle, and the predetermined function of the vehicle M is performed by performing the first process and the second process. Accordingly, it is possible to perform more appropriate processes using a plurality of controllers.

Specifically, according to the embodiment, for example, since updating of a function of an application is completed by rewriting only software of the central ECU 400 for performing the function of the application and updating of a device is completed by rewriting only software of the device ECU 200 or the zone ECU 300, it is possible to minimize the number of ECUS to be rewritten or to be changed. Accordingly, it is possible to achieve an increase in speed of a rewriting process and to realize lean development with enhanced development efficiency or to curb a dark current. For example, since various devices for realizing a predetermined function are mounted in the vehicle M and many device ECUs 200 and zone ECUs 300 are mounted therein, it is possible to achieve more excellent advantages by controlling processes of the ECUs with the aforementioned configuration.

According to the embodiment, for example, the first input process such as a filtering process which is a data thinning process can be performed by one of the central ECU 400 and the zone ECU 300 according to communication conditions. According to the embodiment, since the central ECU 400 is not affected even when change of a device ECU 200, rewriting of software, or the like occurs, it is possible to decrease costs in the rewriting process and the like. According to the embodiment, by employing a configuration in which some details of vehicle control due to occurrence of a predetermined event or the like can be processed by the zone ECU 300 without using the central ECU 400, it is possible to achieve an increase in process speed in the whole vehicle control system or enhancement in process efficiency with distributed loads. According to the embodiment, since an ECU for performing a process can be changed according to load conditions of the communication line (communication bus), it is possible to curb a communication delay or to achieve a decrease in load.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a first controller provided for each device mounted in a vehicle;
a second controller configured to control one or more of the first controllers; and
a third controller configured to control one or more of the second controllers,
wherein each second controller is connected to the corresponding first controller via a communication line and performs a first process based on output information output from the device connected to the first controller,
wherein the third controller is connected to the corresponding second controller via a communication line and performs a second process based on a predetermined function of the vehicle, and
wherein the predetermined function of the vehicle is performed by performing the first process and the second process.

2. The vehicle control system according to claim 1, wherein each first controller includes a first information acquirer configured to acquire first information output from the corresponding device,
wherein each second controller includes a signal information extractor configured to extract signal information from the first information detected by the first information acquirer as the first process, and
wherein the third controller includes a first function controller configured to perform the predetermined function of the vehicle on the basis of the signal information extracted by the signal information extractor as the second process.

3. The vehicle control system according to claim 2, wherein the signal information extractor performs a filtering process of dividing the first information into the signal information and noise information and outputs the signal information to the third controller.

4. The vehicle control system according to claim 2, wherein each second controller further includes a second function controller configured to perform the predetermined function of the vehicle on the basis of the signal information extracted by the signal information extractor, and
wherein the third controller further includes a switcher configured to perform a switching process of switching between whether the predetermined function of the vehicle is to be performed by the first function controller and whether the predetermined function of the vehicle is to be performed by the second function controller.

5. The vehicle control system according to claim 4, wherein the third controller detects a traffic volume in a communication line connecting the third controller and the one or more second controllers and performs the switching process according to the detected traffic volume.

6. The vehicle control system according to claim 5, wherein the third controller causes the switcher to perform the switching process and causes the second function controller to perform the predetermined function of the vehicle as the second process when the traffic volume of the communication line is greater than a predetermined volume.

7. The vehicle control system according to claim 1, wherein the third controller determines operation details for performing the predetermined function of the vehicle as the second process,
wherein one of the third controller and the second controller generates an operation command based on the operation details on the basis of the determined operation details,
wherein the second controller generates operation execution information based on the device connected to the corresponding first controller as the first process, and
wherein the first controller causes the device to perform the predetermined function of the vehicle on the basis of the operation execution information.

8. The vehicle control system according to claim 7, wherein, when a predetermined event occurs in the vehicle, the corresponding second controller generates operation execution information for causing the device connected to the corresponding first controller to perform the predetermined function of the vehicle, and
wherein the first controller performs the predetermined function of the vehicle on the basis of the operation execution information.

9. A vehicle control method that is performed by a computer of a vehicle control system including a first controller provided for each device mounted in a vehicle, a second controller configured to control one or more of the first controllers, and a third controller configured to control one or more of the second controllers, the vehicle control method comprising:
causing each second controller to perform a first process based on output information output from the device connected to the corresponding first controller;
causing the third controller to perform a second process based on a predetermined function of the vehicle; and
causing the device to perform the predetermined function of the vehicle by performing the first process and the second process.

10. A non-transitory computer-readable storage medium storing a program, the program causing a computer of a vehicle control system including a first controller provided for each device mounted in a vehicle, a second controller configured to control one or more of the first controllers, and a third controller configured to control one or more of the second controllers to perform:
causing each second controller to perform a first process based on output information output from the device connected to the corresponding first controller;
causing the third controller to perform a second process based on a predetermined function of the vehicle; and
causing the device to perform the predetermined function of the vehicle by performing the first process and the second process.
